(19) United States
(12) Patent Application Publication
(10) Pub. No.: US 2005/0272430 A1
(43) Pub. Date: Dec. 8, 2005

(54) Reconfigurable micro-mesh communication system

(76) Inventor: John L. Griebling, Highlands Ranch, CO (US)

Correspondence Address: CHRISTIE, PARKER & HALE, LLP, PO BOX 7068, PASADENA, CA, 91109-7068, US

(21) Appl. No.: 10/843,210

(22) Filed: May 10, 2004

(51) Int. Cl. H04Q 7/20

(52) U.S. Cl. 455/446; 370/338

(57) ABSTRACT

Wide area wireless networks with high network throughput and low provisioning and maintenance costs. The wireless networks comprise a distributed reconfigurable micro-mesh cluster having direct wireless link capability. Multiple channels operating at different frequencies can be used per direct wireless link. To further reduce the provisioning and maintenance costs, narrow beam antennas are used at the point of presence. To expand the wide area wireless networks into the home market, adjustable antennas are installed at homes.

### BACKGROUND OF THE INVENTION

The present invention relates generally to the field of telecommunications and, more particularly, to wide-area wireless networks.

Wireless networks allow mobile devices to wirelessly communicate with a wired network, such as the Internet. Wireless networks typically include mobile devices and wireless access points, which are portals to the wired network. The wired network may include gateways that provide links to a point of presence via fixed wires. The point of presence generally provides access to additional networks, such as the Internet.

Typically, a mobile device enters the coverage area of an access point. Communication with the access point is often performed using IEEE 802.11 standards, a family of specifications for wireless networks. The access point communicates with a gateway providing a link to the point of presence, which in turn provides a connection to the Internet. Use of communication 802.11 protocols, such as 802.11b for example, effectively replaces an Ethernet cable between an access point and a computer with a wireless link. Moreover, considering the 802.11b standard, each 802.11b access point can support dozens of mobile devices by sharing 11 Mbps of capacity. There can be up to three access points working in the same area, and each typically has an range of 80 feet at 11 Mbps and 300 feet at 1 Mbps.

The link to the point of presence is generally provided by a fixed wire, such as coaxial cable or twisted pair, between the gateway and the point of presence. In a wired mesh network where the link to the point of presence is provided by a fixed wire, an access point forwards the signal received from the mobile device to another access point. The signal may hop through several access points to reach a gateway, which is available to forward the signal to the point of presence via a fixed wire. An unrestricted number of hops between on access point and a gateway may cause delays and decrease the network throughput. Moreover, a network with a large number of access points providing communication between the point of presence and the mobile devices via fixed wires results in high network provisioning and maintenance costs.

An expected area of expansion for wide area networks is providing residential Internet Service Provider (ISP) services. A difficulty in providing such services is due to barriers, such as walls inside of a residential home, that causes attenuation in the signal strength.

### BRIEF SUMMARY OF THE INVENTION

In one aspect, the invention provides a reconfigurable micro-mesh topology for a wireless network. The topology comprises a plurality of geographically spread gateways, a plurality of geographically spread access points, where each of the plurality of access points is in data communication with other access points and at least one gateway from the plurality of geographically spread gateways. The plurality of gateways are interspersed among the plurality of access points. The topology comprises a point of presence in data communication with the plurality of access points via direct wireless links provided by the plurality of gateways.

In a further aspect, the invention provides a distributed reconfigurable micro-mesh cluster for a wireless network. The cluster comprises a plurality of reconfigurable micro-mesh networks. Each of the micro-mesh networks comprises a plurality of geographically spread gateways and a plurality of geographically spread access points. Each of the plurality of access points is in data communication with other access points and at least one gateway from the plurality of geographically spread gateways. The plurality of gateways are interspersed among the plurality of access points. Each of the micro-mesh networks is interconnected to other micro-mesh networks via first direct wireless links. A point of presence is in data communication with the plurality of access points in the plurality of reconfigurable micro-mesh networks via second direct wireless links provided by the plurality of gateways.

These and other aspects of the invention are more fully appreciated upon review of this disclosure including the associated figures.

### BRIEF DESCRIPTION OF THE DRAWINGS

FIG. 1 illustrates an embodiment of a single reconfigurable micro-mesh constructed in accordance with aspects of the invention.

FIG. 2 illustrates an embodiment of distributed reconfigurable micro-mesh cluster constructed in accordance with aspects of the invention.

FIG. 3 illustrates an application of a micro-mesh network of FIG. 1 in a residential setting.

FIG. 4 is an illustrative view of access point nodes and wireless gateway nodes providing a sparse micro-cell coverage.

FIG. 5 is an illustrative view of access point nodes and wireless gateway nodes providing a dense micro cell coverage.

FIG. 6 is an illustrative view of a dense micro-cell coverage in an approximate one square mile cluster.

FIGS. 7A-7B illustrate various views of an embodiment of a point of presence constructed in accordance with aspects of the invention.

FIG. 8 illustrates a geographic view of reconfigurable micro-mesh clusters in data communication with a point of presence in the City of Cerritos, Calif.

FIG. 9 illustrates an embodiment of a point of presence comprising beam antennas constructed in accordance with aspects of the invention.

### DETAILED DESCRIPTION

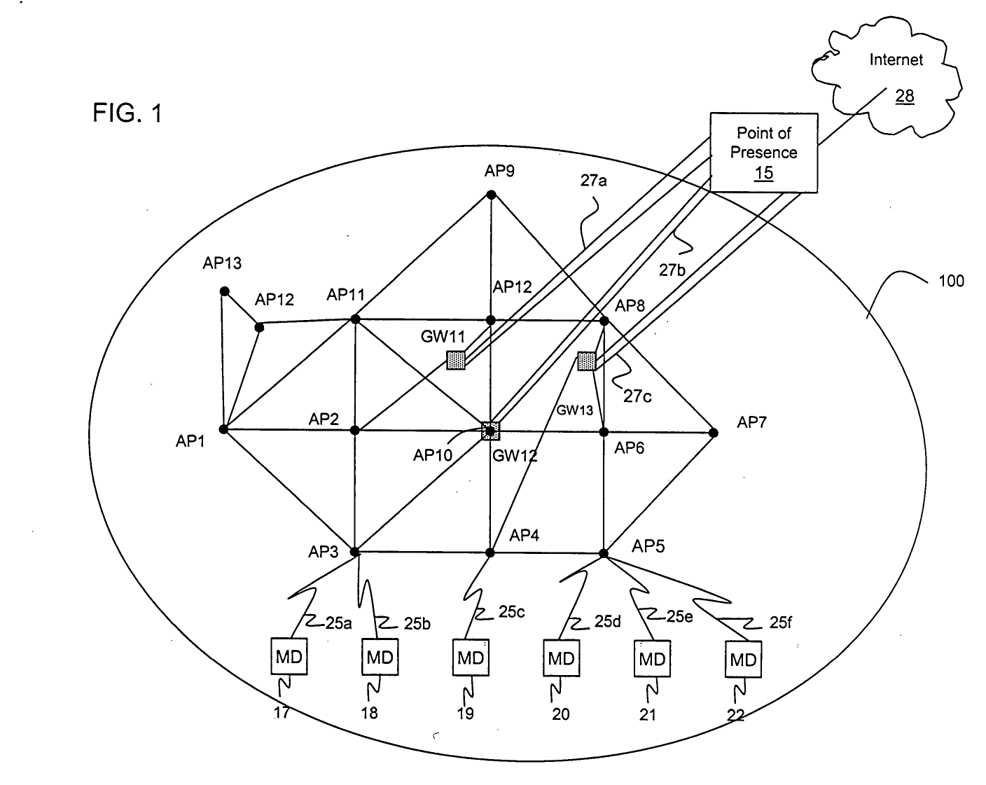

FIG. 1 illustrates a reconfigurable micro-mesh network in accordance with aspects of the invention. As illustrated in FIG. 1, a reconfigurable micro-mesh network includes a number of geographically spread access points AP 1-13. The access points are geographically spread to provide coverage to a service area 100. As illustrated, the service area covers a contiguous area. In other embodiments the service area may cover a discrete number of separated areas.

In the network, each of mobile devices 17-22 within the service area 100 communicates with an access point. To transmit data from the mobile devices 17-22 to the Internet 28 and vice versa, an access point in communication with one or more mobile devices communicates with a gateway 11, 12, 13. The access point communicates with the gateway either directly or over a limited number of hops across other access points. The gateways 11-13 respectively provide direct wireless links 27a-c to a point of presence 15, which is a portal to the Internet 28. As illustrated in FIG. 1, the point of presence is outside of the service area, although in other embodiments, the point of presence is within the service area.

A mobile device, denoted as MD 17, 18, 19, 20, 21, 22, in various embodiment is any sort of a device that has wireless communication capability, including but not limited to handheld, small, and large computers, personal digital assistants, peripherals, appliances, machines, telephones, toys, games, and so on. In the example of FIG. 1, mobile devices 17-22 are in the service area 100 that is serviced by the micro-mesh network of access points AP 1-13 and the gateways GW 11-13.

More specifically, for example, as the mobile device 17 enters the communication range of the access point AP3, the strength signals 25a between the mobile device 17 and the access point AP3 increases. The access point AP3 detects the presence of the mobile device 17 based on the strength of the signal received from the mobile device 17. Upon detection by the access point, a respective wireless connection, e.g., connection 25a, establishes communication between the detected mobile device and the access point. The wireless connection transports data between the mobile device and the access point AP3.

In some implementation, multiple mobile devices are in communication with a single access point. For example, as the wireless connection 25a is established between the mobile device 17 and the access point AP 3, a mobile device 18 may also enter the communication range of the access point AP 3. The access point AP 3 detects the presence of the mobile device 18 based on the strength of the signal received from the mobile device 18. A wireless connection, 25b, is established between the mobile device 18 and the access point AP3. Similarly, a mobile device 19 enters the communication range of an access point AP4. Detecting the presence of the mobile device 19, a wireless connection, e.g., 25c, is established between the mobile device 19 and the access point AP4. Mobile devices 20, 21, and 22 enter the communication range of an access point AP5. Detecting the presences of these mobile devices, wireless connections between the access points, e.g., 25d, 25e, and 25f respectively, are established communication between the detected mobile devices and the access point.

The wireless connection 25a as well as other wireless connections can be implemented with a wireless networking protocol, such as IEEE 802.11 (e.g., 802.11a, 802.11b, 802.11g) and other protocols. In typical implementations, each of the wireless networks 25 is a radio frequency (RF) based network, operating at 900 MHz, 2.4 GHz, or 5 GHz. In another implementation, although not shown in FIG. 1, a private wireless network can be supported within privately owned spectrum.

In FIG. 1, access points are shown as dark circles and the access points are denoted as AP 1 to AP 13, respectively. Although only thirteen access points are shown for an illustrative purpose, larger number of access points can be included and supported by the reconfigurable micro-mesh network. Each of the access points AP 1-13 may be a relatively simple communication device that relays data communication. In one example, the access points AP 1-13 may be designed for indoor or outdoor installation. The access points may communicate with each other wirelessly through a protocol implementing a mesh routing algorithm. In one example, the access points may support a single or dual radio configuration for 11, 5.5, 2, and 1 Mbps connectivity in frequency band 2.4-2.483 GHz, fully compliant with the IEEE 802.11b standard in some embodiments. Each access point may comprise a processor such as IBM Power PC 405 operating at 200 MHz, a system memory, such as 16 Mbytes RAM and 8 Mbytes FLASH. Each access points may also provide full virtual private network (VPN) compatibility to allow access to only authorized VPN servers. Examples of access points include, but are not limited to, a Tropos 3110 Indoor wi-Fi Cell and a Tropos 5110 Outdoor Wi-Fi Cell from Tropos Networks, San Mateo, Calif.

The access points 1-13 are geographically spread throughout the service area 100. The geographically spread access points 1-13 are generally arranged in a mesh-like network, where each node (access point) communicates directly with other access points within range in the network. In the example of FIG. 1, some access points only communicate with other access points. In some instances, access points communicate directly with other access points and with at least one gateway. Thus, an access point may be directly in data communication with a gateway and/or with another access point. For example, in the reconfigurable micro-mesh network of FIG. 1, access point AP 1 can directly communicates with access points AP 2, AP 3, or AP 11-13. Although not directly communicating with any gateways, AP 1 may hop to AP 11 to communicate with a gateway GW 12. Alternatively, AP1 may hop to AP2 to communicate with GW 11. AP 3 can communicate with other access points, such as AP 1, AP 2, AP4, AP 10 or directly with the gateway GW 12. Establishing a direct communication between the gateway 2 and the access point AP 3 provides a higher network throughput than hopping through other access points to reach another gateway.

Furthermore, the access points may use the same or different protocols to communicate with the gateways GW 11-13. However, in some instances, the gateway GW 2 may be too busy or overloaded, thus the data transmitted from either MD 17 or MD 18 to the access point AP 3 would hop to other access points to reach an available gateway in the mesh network. The access point AP 10, co-located in the same node as the gateway GW 12, acts as another hopping point. To provide high network throughput, hops are made at most a limited number. In some embodiments, the number of hops are limited to three.

In some embodiments, a reconfigurable micro-mesh network allows dynamic reconfiguration of communication between the access points. For example, if the access point AP3 is in communication with the access point AP2, the access point AP3 may switch to a different access point, such as AP1, AP10, or AP4 that is less busy than AP2 to improve the network throughput. In some other embodiments, in the same example, where AP3 is in communication with the access point AP2, the access point AP3 may also be in communication with several access points at the same time to prevent overloading just one access point thus evenly distributing the load among several access points to improve the network throughput.

Also in FIG. 1, three gateways are shown as shaded boxes and the gateways are denoted as GW 11-13 within the service area 100. Although only three gateways are shown for an illustrative purpose, a larger number of gateways can be included and supported by the mesh network. In some embodiments, gateways outside of the service area may establish communication with the nodes in the mesh network.

A wireless gateway allows mobile devices and access points to share data and a WAN connection without hard-wired cables. A gateway can also be implemented as, or as part of, any other suitable network device with software to implement the functions described herein. The gateway can be implemented as a server-class computer, such a PC having a CPU board containing at least one processor. The processors may be selected from the Pentium or Celeron family of processors manufactured by Intel Corporation of Santa Clara, Calif. The server computer also includes a main memory unit for storing programs and/or data. The memory capacity may include random access memory (RAM), read only memory (ROM), and FLASH memory.

The gateways may also include a server-class operating system, such as Linux, available, for example, from Red Hat, Inc. of Durham, N.C., and Windows NT, available from Microsoft Corporation of Redmond, Wash.

The gateways may also include IPSec or PPTP functionality according to the standards. Various software implementations of IPSec are available, including, for example, from Trilogy of Austin, Tex., Windows XP Pro IPSec Client, Windows 2000 IPSec Client, Safenet IPSec Client for Windows NT, Safenet IPSec Client for Windows 2000, SSH Sentinal IPSec Client for Windows NT or Windows 2000 from Microsoft Corp. of Redmond, Wash. Examples of software implementations of PPTP include, but are not limited to, the Windows 2000/XP/NT Client by Microsoft Corp. of Redmond, Wash. IPSec acts at the network layer, protecting and authenticating data between participating devices, such as the access points and gateways.

The gateways GW 11-13 are interspersed among the access points and each of the gateways GW 11-13 respectively provides a direct wireless link 27a, 27b, 27c, to the point of presence 15. In some instances, an access point and a gateway are co-located within the same node in the mesh network. For example, the AP 10 and the GW 12 are co-located at the same location, or alternatively forming the same node in the mesh network.

In one embodiment, each of the gateways GW 11-13 provides data communication between the wireless network to which an access point is associated and a wireless link to the point of presence 15. To establish data communication, the geographically spread gateways GW 11-13 are interspersed among the access points AP 1-AP 10 in the service area 100. For example, in FIG. 1, the GW 11 is interspersed between AP 2 and AP 11, and GW 13 is interspersed among AP 4, AP 6, and AP 8. Because the gateways are connected to the point of presence 15 via flexible wireless links, rather than fixed wires, the position of the gateways can be changed within the mesh network. Moreover, additional gateways can be added to the mesh network. Thus, interspersion of gateways among the access points can be achieved without requiring modifications to other hardware of the network.

In one embodiment, the direct wireless links 27a-c are single channel links, providing one channel per link, to the POP 15. In some other embodiments, at least some of the direct wireless links 27a-c may provide multiple channels to transport signals at differing frequencies to the POP 15. In one example, the wireless networks 25 are RF-based networks, operating at 900 MHz, 2.4 GHz, or 5 GHz. In this example, the direct wireless links 27a-c may provide multiple channels, where a first channel at 900 MHz, a second channel at 2.4 GHz, and/or a third channel at 5 GHz to the POP 15. Thus in some implementations, a single gateway can communicate with two or three access points at a time, each effectively transporting signals at different frequencies by way of the gateway to the POP 15. Accordingly, the use of multiple channels further increases the network throughput by simultaneously transporting signals at differing frequencies to the POP 15.

The point of presence (POP) 15 is a portal to the Internet 28. A POP is hardware that in various embodiments, comprises servers, routers, ATM switches and digital/analog call aggregators.

In some embodiments, the POP includes multiple beam antennas, where each of the beam antennas has a reflector that focuses the signal received from gateways and transmitted to gateways. Installing reflectors only at the POP, rather than installing a reflector at each gateway and focusing the signal to the POP, further reduces the network provisioning and maintenance costs.

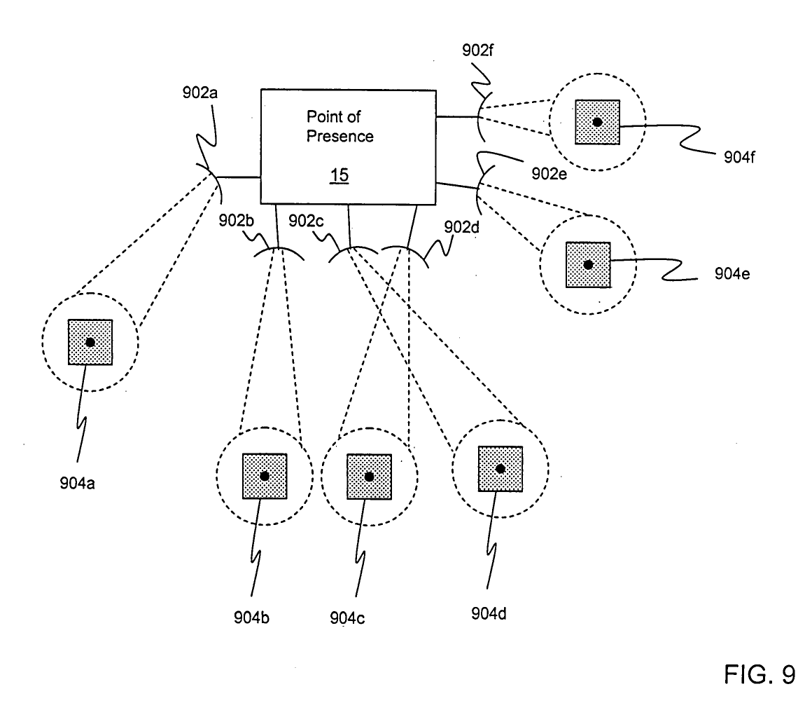

FIG. 9 illustrates an embodiment of a POP comprising beam antennas constructed in accordance with aspects of the invention. In the example of FIG. 9, a POP 15 includes beam antennas 902a-f, each of which has a reflector. Signals communicated from various gateways are shown in dotted lines. Shaded squares represent gateways, which are denoted as 904a-f, and the dots inside of the squares represent access points in data communication with the respective gateways. As illustrated in FIG. 9, the phase of the reflector is adjusted to receive signal from a specific gateway and reflect signal onto the gateway. For example, the gateway 904a is in data communication with the antenna 902a. The gateway 904b is in data communication with the antenna 902b. The gateway 904c is in data communication with the antenna 902c. The gateway 904d is in data communication with the antenna 902d. The gateway 904e is in data communication with the antenna 902e. The gateway 904f is in data communication with the antenna 902f. As described in the discussion of FIG. 1, the gateways can be moved to different locations and new gateways can be added due to wireless links connecting the gateways to/from the POP 15. To accommodate such flexibility in the gateway arrangements, the phases or aiming of the beam antennas 902a-902f are adjustable and additional beam antennas can be added as desired.

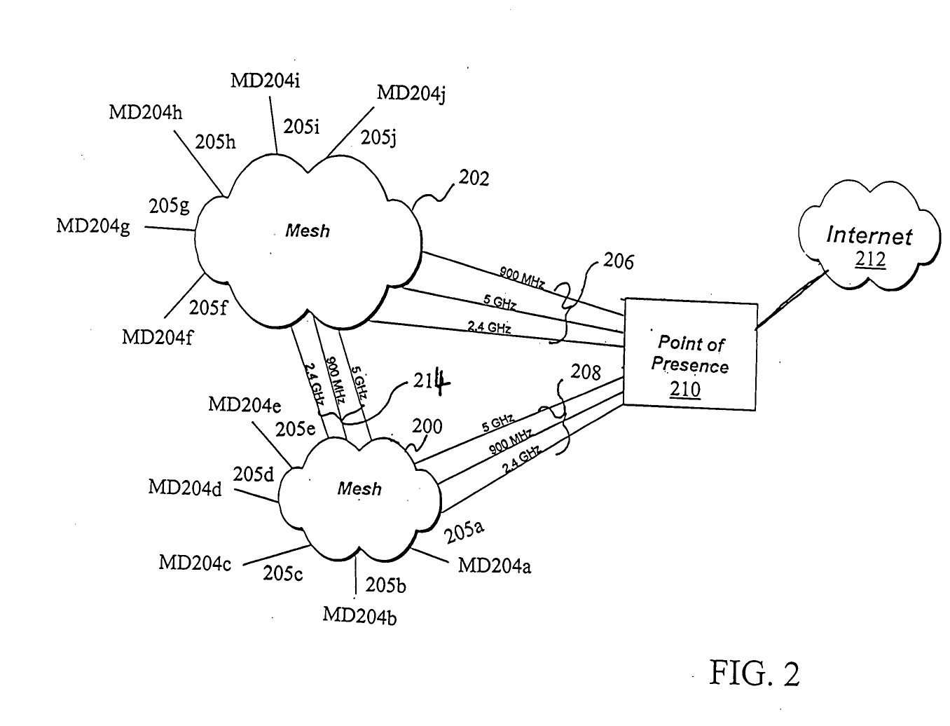

FIG. 2 illustrates an embodiment of a distributed reconfigurable micro-mesh cluster constructed in accordance with aspects of the invention. Two or more geographically spread reconfigurable micro-mesh networks are in communication to form a distributed mesh cluster. Although only two mesh networks are shown in FIG. 2 for an illustrative purpose, any number of distributed networks can be interconnected to form a distributed reconfigurable mesh cluster to cover one service area or several service areas. In one embodiment, the service area may cover a discrete number of separate areas within the same service area. In that instance, each mesh network establishes a network for the separate areas within the service area. In some other embodiments, the service area may cover a contiguous area. In that instance, each mesh network establishes a network for different service areas. Mesh networks 200 and 202 provide wireless data communication between mobile devices 204a-204j and wired networks, such as the Internet 212. To establish such wireless communication, the mesh networks 200 and 202 transport data from/to the mobile devices 204a-j through wireless networks 205a-j and then through direct wireless links 206, 208, 214.

In the illustrative embodiment of FIG. 2, the mobile devices MDs 204a-j are 802-11b or 802.11g Wi-Fi (wireless Ethernet) client devices. Thus, the wireless networks 205a-j, establishing data communication between the MDs 204a-j, are radio frequency (RF) based networks, operating at 900 MHz, 2.4 GHz, or 5 GHz. The mesh network 200 is in communication with the mobile devices MD 204 a-e and the mesh network 202 is in communication with the mobile devices MD 204f-j.

In FIG. 2, two mesh networks 200 and 202 are in data communication with each other via direct wireless links to form distributed reconfigurable micro-mesh clusters. Each of the mesh networks 200, 202 is similar to the micro-mesh network of FIG. 1. For instance, each of the mesh networks 200, 202 comprises geographically spread gateways and geographically spread access points. The access points are generally arranged in a mesh-like network, where each of the access point is in direct data communication with the other access points. Similar to the micro-mesh network of FIG. 1, the gateways are interspersed among the access points. Thus, in the example of FIG. 2, an access point may only be in direct communication with some of the other access points. An access point may also be in direct communication with some access points and with at least one gateways. Also similar to the micro-mesh network of FIG. 1, each of the access points can communicate with one or more mobile devices, MD 204 a-j, entering the respective coverage area.

Each of the gateways of mesh networks 200 and 202 provides direct wireless links 206 and 208, alternative to DSL and cable modem, to a point of presence (POP) 210. Because the gateways are wirelessly linked to the POP 210, the position of the gateways can be changed as needed to forward the data to and from the mobile devices. Likewise, more gateways can be added to the respective mesh network to increase the network throughput. To further improve the network throughput, one or both of the direct wireless links 206 and 208 have multiple channels at different frequencies. For example, to be in data communication with the RF-based networks 205a-j, operating at 900 MHz, 2.4 GHz, or 5 GHz, the wireless direct links 206 and 208 support multiple channels at 900 MHz, 2.4 GHz, and/or 5 GHz. Thus in some implementations, a single gateway can communicate with two or three access points at a time, each transporting signals to the POP at different frequencies.

Also in the embodiment of FIG. 2, direct wireless link 214 provides interconnection between the mesh networks 200 and 202. Similar to the wireless links 206 and 208, the wireless link 214 provides multiple channels at different frequencies. To be in data communication with the RF-based networks 205a-j, operating at 900 MHz, 2.4 GHz, or 5 GHz, the direct wireless link 214 has multiple channels at 900 MHz, 2.4 GHz, and/or 5 GHz. Thus, multiple signals from various access points at differing frequencies can be served by the wireless link 214 simultaneously.

The direct wireless link 214 transports data across the mesh networks. For example, in the mesh network 200, an access point establishes data communication with a mobile device MD 204a. If the gateway directly adjacent to the access point is too busy to handle the data received from the mobile device 204a, the access point forwards the data to another access point. To provide high network throughput, the number of hops between one access point to another access point to reach a gateway is restricted to a limited number, for example to three. Instead of hopping through the access points within the same mesh network, the data can be transported to the gateways in other mesh networks in the distributed cluster, such as the mesh network 202. Thus, the data can be transported across the direct wireless link 214 to an available gateway in the mesh network 202. The recipient gateway directly forwards the data to the POP 210 via the direct wireless link 206.

Similar to the POP of FIGS. 1 and 9, the POP 210 is located outside of the service areas covered by the mesh networks 200, 202. In some embodiments, the POP 210 of FIG. 2 includes narrow beam antennas, each of which has a reflector. Each reflector increases the power of the signal received from a specific gateway in the plurality of geographically spread gateways.

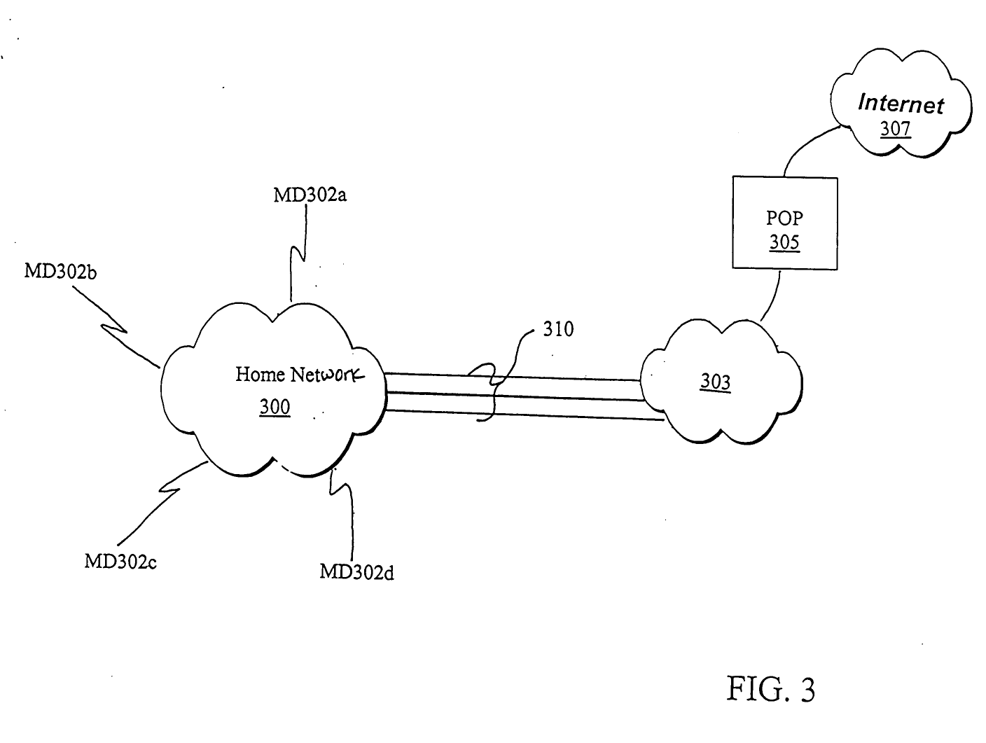

FIG. 3 illustrates a reconfigurable micro-mesh network expanding wide area wireless networks in a residential setting. In a home, a mobile device may be one of various electronic devices, desktop and laptop computers, printers, set-top boxes and other appliances that include wireless networking hardware. In one implementation, Wi-Fi bridges can convert any electronic devices having wireless networking hardware into mobile devices. For example, in FIG. 3, mobile devices MDs 302a-d are such electronic devices having wireless networking hardware. Examples of Wi-Fi bridges include, but are not limited to, ZyAir B-2000 or B-4000 from ZyXEL Communications Corp., among many others.

A home network 300 is a subnet in a reconfigurable micro-mesh network acting as an ISP for the mobile devices. The home network 300 has Wi-Fi bridges, which include access points and gateways. A non-home network 303 also forms a subnet in the same micro-mesh network. The non-home network 303 comprises geographically spread access points and geographically spread gateways interspersed among the access points. The gateways in the non-home network 303 provide direct wireless links to the POP 305, which in turn transport data between the mobile devices MDs 302a-d and the Internet 307, a WAN, or some other wireless or wired networks.

The inside of a home has many obstacles, such as walls and doors, that cause attenuation of wireless signals. To increase the strength of the wireless signals, an antenna is used inside, for example, of a home. In one embodiment, an antenna is a positional dependent antenna such as an antenna array or a phased array antenna. In some embodiments, an actuator moves the antenna and provides a signal indicative of received signal strength for each position of the antenna. The signal is provided to a computer, either on board or the user's PC, which determines a preferred current position of antenna. The computer forwards the preferred current position of the antenna to the actuator and the actuator sets the antenna to the position until the next period of sweep-through. In one example, the preferred current position is the position that provides the strongest signal strength among the various positions of the antenna within a predefined period.

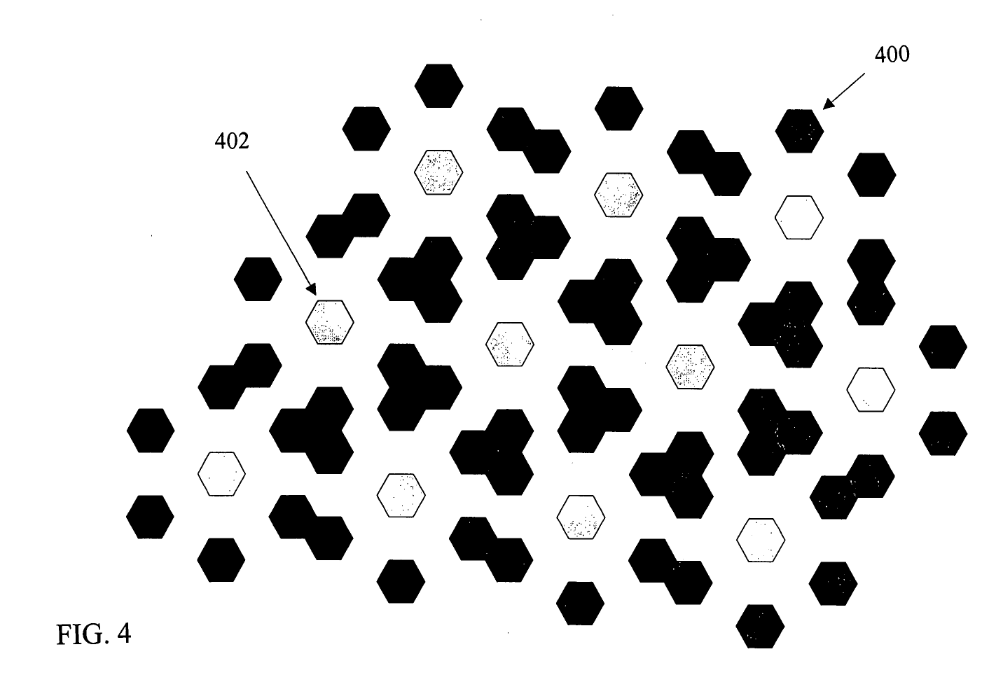

FIG. 4 is an illustrative view of access point nodes and wireless gateway nodes providing a sparse micro-cell coverage. In FIG. 4, black polygons represent access points 400 and gray polygons represent wireless gateways 402 providing direct wireless links to a POP. Each of the access points 400 and the gateways 402 is geographically separated from other access points and gateways. The gateways 402 are injected into a mesh network and are interspersed among the access points 400.

Each gateway is in data communication with the surrounding access points and for these access points, the gateway provides direct wireless links to and from the POP (not shown). At least some of the gateways have multiple channels. For RF wireless networks, each of these direct wireless links simultaneously provides a 900 MHz channel, a 2.4 GHz channel, and/or a 5 GHz channel. In some embodiments, signals at different frequencies can be transported to/from the wired network simultaneously.

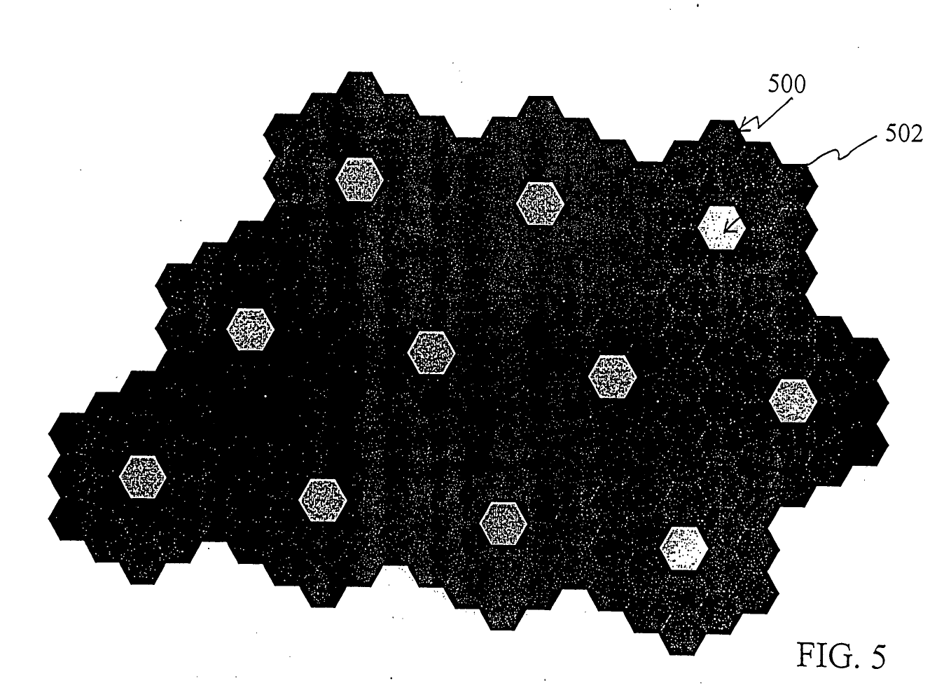

FIG. 5 is an illustrative view of access point nodes and wireless gateway nodes providing a dense micro cell coverage. In FIG. 5, black polygons 500 represent access points and gray polygons 502 represent wireless gateways 502 providing direct wireless links to a POP. The access points 500 are densely positioned, such that each access point is in direct communication with other access points and that there are no gaps among the access points. The gateways 502 are injected into the mesh network and are interspersed among the access points 500.

Each gateway is in data communication with the surrounding access points. For these access points, the gateway provides direct wireless links to and from the POP (not shown). At least some of the gateways have multiple channels. For RF wireless networks, each of these direct wireless links simultaneously provides a 900 MHz channel, a 2.4 GHz channel, and/or a 5 GHz channel. In some embodiments, signals at different frequencies can be transported to/from the wired network simultaneously.

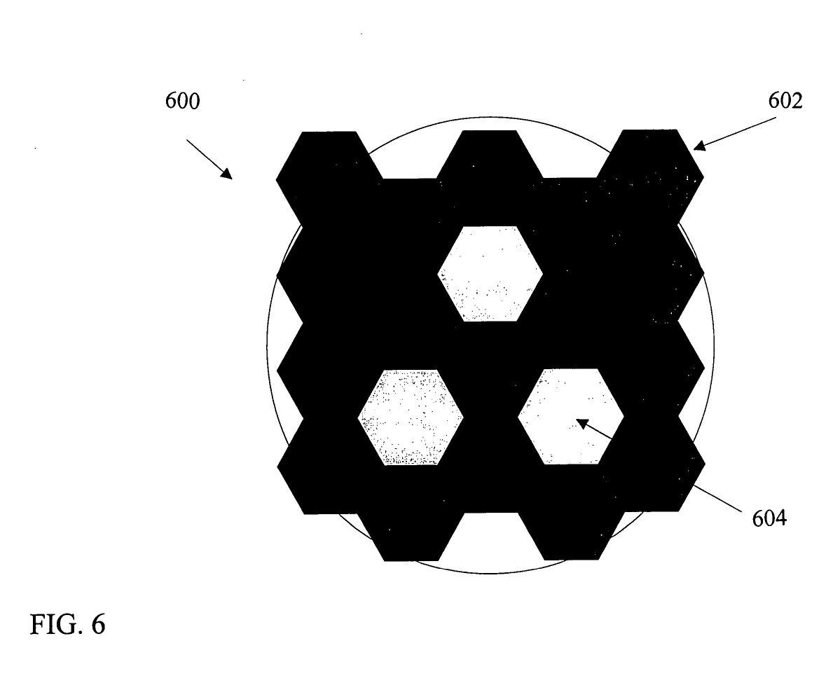

FIG. 6 is an illustrative view of a dense micro-cell coverage in an approximate one square mile cluster. Approximate one square mile cluster 600 comprises around 20 access points 602, represented in black polygons. Interjected and interspersed among the access points 602 are wireless gateways 604. Each gateway is in data communication with the surrounding access points and for these access points, the gateway provides direct wireless links to and from the POP (not shown).

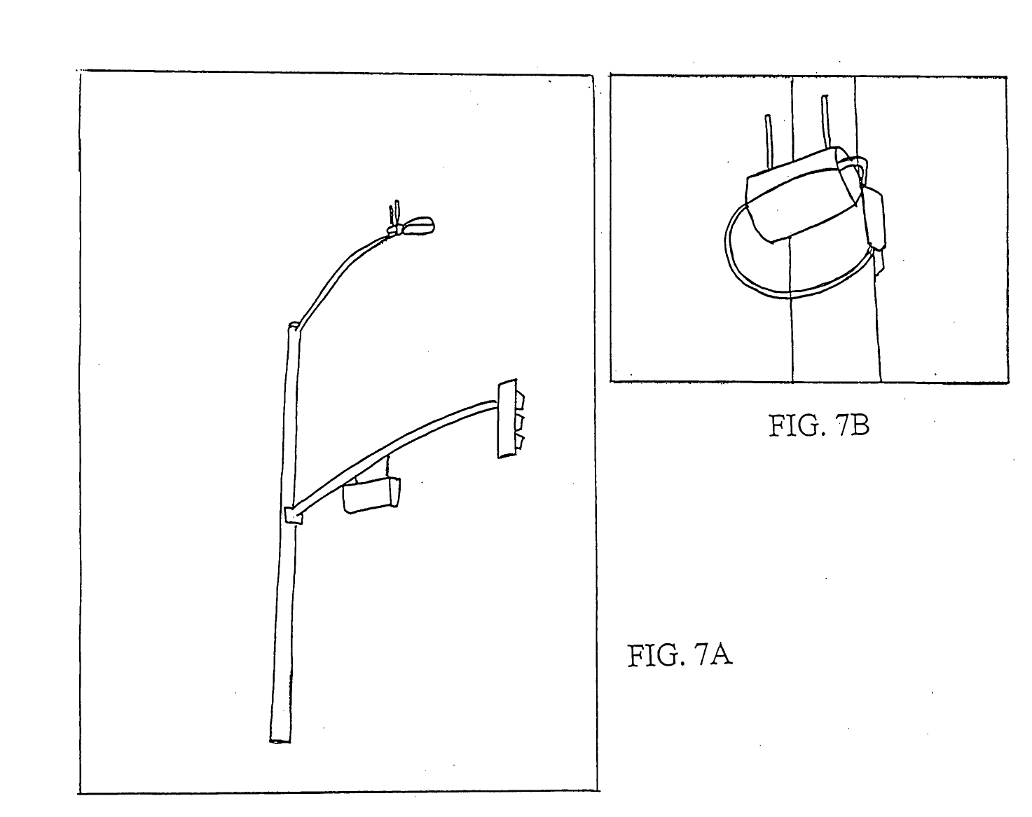

FIGS. 7A and 7B illustrate various views of an exemplary access point constructed in accordance with aspects of the invention. FIG. 7A depicts an access point installed on the top of a street light. FIG. 7B depicts a close-up view of the access point.

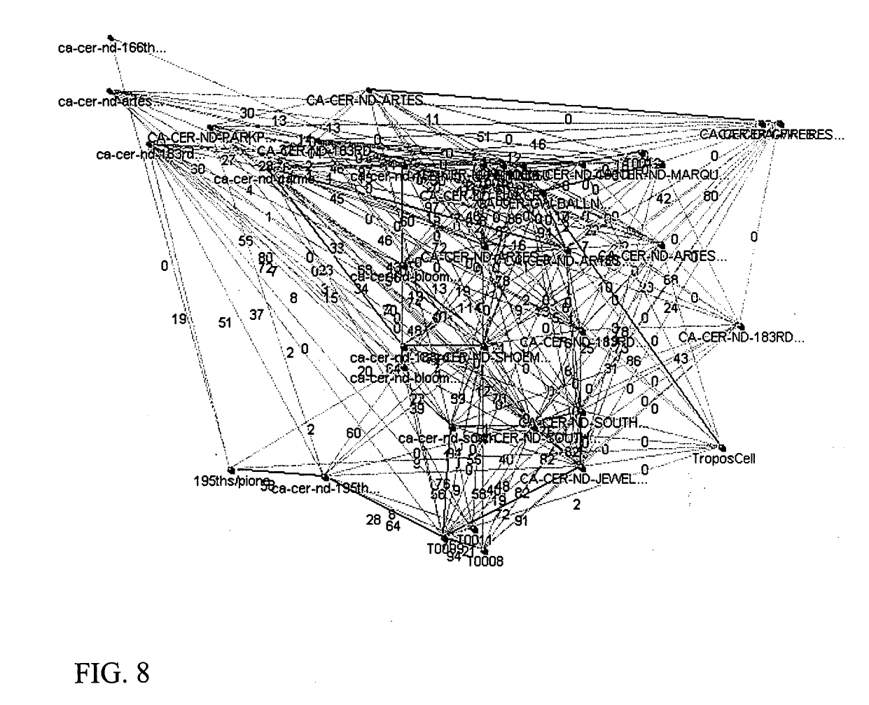

FIG. 8 illustrates a geographic view of reconfigurable micro-mesh clusters providing wide area wireless networks. The geographic view represents the reconfigurable micro-mesh clusters located in City of Cerritos, Calif. Geographically spread access points are arranged in a manner similar to a mesh network. The wireless gateways are interspersed among the access points. The wireless gateways provide direct wireless links to the POP 800.

Although this invention has been described in certain specific embodiments, many additional modifications and variations would be apparent to one skilled in the art. It is therefore to be understood that this invention may be practiced otherwise than is specifically described. Thus, the present embodiments of the invention should be considered in all respects as illustrative and not restrictive. The scope of the invention to be indicated by the appended claims, their equivalents, and claims and their equivalents supported by the specification rather than the foregoing description.

1. A reconfigurable micro-mesh topology for a wireless network, the topology comprising:
a plurality of geographically spread gateways;
a plurality of geographically spread access points, wherein each of the plurality of access points is in data communication with other access points and at least one gateway from the plurality of geographically spread gateways, the plurality of gateways interspersed among the plurality of access points;
a point of presence in data communication with the plurality of access points in via direct wireless links provided by the plurality of gateways.

2. The reconfigurable micro-mesh topology of claim 1, wherein the plurality of geographically spread access points are in communication with a second network.

3. The reconfigurable micro-mesh topology of claim 1 further comprising a positional dependent antenna.

4. The reconfigurable micro-mesh topology of claim 3, wherein the positional dependent antenna is an antenna array.

5. The reconfigurable micro-mesh topology of claim 3, wherein the positional dependent antenna is a phased array antenna.

6. The reconfigurable micro-mesh topology of claim 3, wherein the positional dependent antenna comprises an actuator that controls movement of the antenna and adjusts the antenna to a preferred current position.

7. The reconfigurable micro-mesh topology of claim 1, wherein at least one of the plurality of direct wireless links comprises a plurality of channels transporting signals to the point of presence at different frequencies.

8. The reconfigurable micro-mesh topology of claim 1, wherein at least one gateway from the plurality of gateways provides a plurality of channels to the point of presence at different frequencies.

9. The reconfigurable micro-mesh topology of claim 8, wherein the different frequencies comprise different radio frequencies.

10. The reconfigurable micro-mesh topology of claim 1, wherein the point of presence comprises a plurality of narrow beam antennas, each of the plurality of beam antennas having a reflector, the reflector increasing power of signal received from a specific gateway from the plurality of geographically spread gateways.

11. The reconfigurable micro-mesh topology of claim 1, wherein at least some of the plurality of access points are in data communication with at least one gateway from the plurality of gateways through other access points.

12. A distributed reconfigurable micro-mesh cluster for a wireless network, the cluster comprising:
a plurality of reconfigurable micro-mesh networks, each of the micro-mesh networks comprising a plurality of geographically spread gateways and a plurality of geographically spread access points, wherein each of the plurality of access points is in data communication with other access points and at least one gateway from the plurality of geographically spread gateways, the plurality of gateways interspersed among the plurality of access points, each of the micro-mesh networks interconnected to other micro-mesh networks via first direct wireless links; and
a point of presence in data communication with the plurality of access points in the plurality of reconfigurable micro-mesh networks via second direct wireless links provided by the plurality of gateways.

13. The distributed reconfigurable micro-mesh cluster of claim 12, wherein at least some access points from the plurality of access points are in data communication with at least one gateway from the plurality of gateways through other access points.

14. The distributed reconfigurable micro-mesh cluster of claim 12, wherein at least one of the first direct wireless links comprises a plurality of channels transporting signals across the micro-mesh networks at different frequencies.

15. The distributed reconfigurable micro-mesh cluster of claim 12 wherein at least one gateway from the plurality of gateways provide a plurality of channels to the point of presence at different frequencies.

16. The distributed reconfigurable micro-mesh cluster of claim 12, wherein at least one of the second direct wireless links comprises a plurality of channels transporting signals to the point of presence at different frequencies.

17. The distributed reconfigurable micro-mesh cluster of claim 12, wherein at least one of the second direct wireless links comprises a plurality of channels operating at different radio frequencies.

18. The distributed reconfigurable micro-mesh cluster of claim 12, wherein the point of presence comprises a plurality of narrow beam antennas, each of the plurality of beam antennas having a reflector, the reflector increasing power of signal received from a specific gateway in the plurality of geographically spread gateways.
